(19) United States
(12) Patent Application Publication
(10) Pub. No.: US 2014/0052539 A1
(43) Pub. Date: Feb. 20, 2014

(54) Aggregating Connections Of Social Networking System Users For Targeting Or Display Of Content

(71) Applicants: Brady Lauback, Palo Alto, CA (US); Paul Adams, San Francisco, CA (US)

(72) Inventors: Brady Lauback, Palo Alto, CA (US); Paul Adams, San Francisco, CA (US)

(21) Appl. No.: 13/586,655

(22) Filed: Aug. 15, 2012

(51) Int. Cl. G06Q 30/02

(52) U.S. Cl. 705/14.66

(57) ABSTRACT

A social networking system determines social statistics for users of the social networking system, where the social statistics are based on connections associated with the users by the social networking system. The social statistics may include aggregations of custom connections with an object in the social networking specified by entity third party system. Connections having a particular connection type are aggregated, and the aggregated connections are used to derive a social statistic. Social statistics may then be used as targeting criteria for an advertisement and/or as content included in the advertisement.

### BACKGROUND

This invention relates generally to aggregating information about the actions or connections of users of a social networking system and then using the aggregated information to target information to users or presenting aggregated information to users about their friends.

Social networking systems allow users to make connections between users and other entities represented in the social networking system. Often, advertisers use these connections to deliver targeted advertisements (“ads”) to social networking system users. Advertisers frequently specify targeting criteria for advertisements used to select users to be presented advertisements. For example, targeting criteria allow various advertisements to be targeted based on demographic information about users or based on particular interests of a user. Advertisers then place bids to the social networking system to present advertisements to users matching the targeting criteria for the advertisements. Typically, the advertisements presented to social networking system users include static content that does not include social information.

However, conventional targeting criteria are typically limited to evaluating information users provide about themselves to a social networking system. In particular, conventional targeting criteria are generally unable to effectively account for user activities on the social networking system. Hence, typical targeting criteria for advertisements fail to capture the full breadth of a user's activities on the social networking system. This lack of information also limits the ability to personalize content (such as advertising) to users.

### SUMMARY

To take advantage of the social information available to a social networking system, the system determines one or more social statistics for users of the system. The social information comprises information maintained by the social networking system that relates the user to various entities in the social networking system. The social information may comprise connections between a user with objects stored on the social networking system, such as pictures, images, videos, audio data, other users, applications, a page associated with a brand, an activity or other objects. Users may form connections with these objects using connections defined by the social network system. The connections have different types, such as comment, like, read, watch, listen to, form a relationship, or any other suitable type. Users or other entities may also define custom connections to allow users to connect with objects associated with the user or entity. For example, a business may provide an application or plug-in for the social networking system, allowing users to interact with the application and form a connection to the application based on parameters defining the connection by the business. The social statistics are determined based on this social information. The social statistics may include aggregations of custom connections with objects in the social networking specified by entity third party system. Connections having a particular connection type are aggregated, and the aggregated connections are used to derive a social statistic. An example of a social statistic is which of a user's friends has listened to a song by a particular artist the most number of times.

Once determined, the social statistics may be used for various purposes, such as targeting criteria for an advertisement or as content included in the advertisement. For targeting, for example, an advertiser may target an advertisement to a user's friend with the most listens of songs by a particular artist. For content included in an advertisement, for example, an advertisement for a new album from the artist may include a statement about how often the viewing user's friends have listened to songs by that artist. Thus, an advertiser may establish an object in the social networking system and allow users to form custom connections, based on advertiser-specific criteria or parameters, with the object.

### BRIEF DESCRIPTION OF THE DRAWINGS

FIG. 1 is a block diagram of a system environment including a social networking system in accordance with an embodiment of the invention.

FIG. 2 illustrates an example social graph in accordance with an embodiment of the invention.

FIG. 3 illustrates an example of connecting social networking system users to an application using custom connection types in accordance with an embodiment of the invention.

FIGS. 4A and 4B illustrate example advertisements incorporating social statistics.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

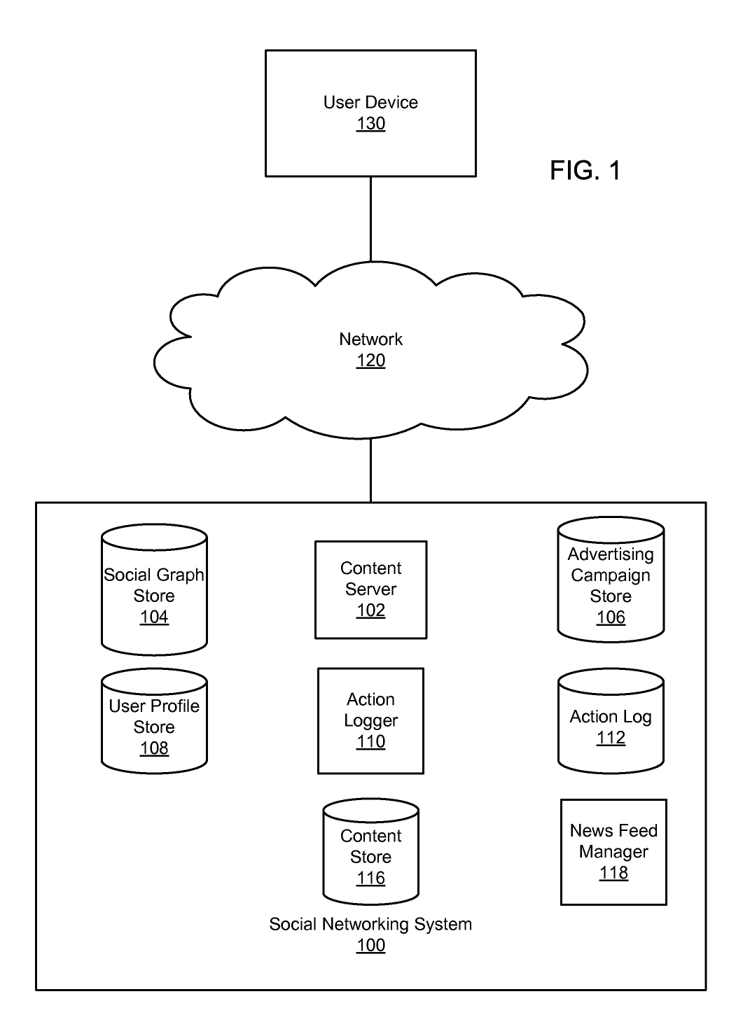

FIG. 1 is a block diagram of one embodiment of a system environment including a social networking system 100. A user device 130 communicates with the social networking system 100 through a network 120. The network 120 may include wireless networks, wired networks, or a combination of network types, and provides a channel for communications between the user device 130 and the social networking system 100, which may be exchanged using any suitable communication protocol or combination of protocols.

While FIG. 1 shows a single user device 130, in practice a plurality of user devices 130 communicate with the social networking system 100. A user of the user device 130 is associated with a profile on the social networking system 100. Using the profile, the social networking system 100 selects social networking content and an advertisement for presentation to the user. As further described below, the advertisement is selected based on one or more social statistics determined by the social networking system 100 and associated with the user. The selected advertisement includes an advertising creative. A social statistic definition is associated with the advertisement for presentation to the user and used to generate a social statistic. Hence, the social statistic definition includes instructions to generate a social statistic statistic (e.g., “how many friends posted a photo in the past week?”) while the generated social statistic is the result of the social networking system 100 following the social statistic definition to determine the social statistic relative to a particular user (e.g. “five of your friends posted a photo in the past week”). The selected content and selected advertisement are provided to the user device 130 for display to the user of the user device 130. For example, selected content and advertisements are provided via a newsfeed or a push notification generated by the social networking system 100 or using any other suitable messaging channels maintained by the social networking system 100. Messaging channels maintained by the social networking system 100 may also be content and advertisements to users though systems external to the social networking system 100, such as a messaging channel using plug-in or iframe in a webpage to access social networking content from a system external to the social networking system 100.

Each user of the social networking system 100 is associated with a user profile, which is stored in a user profile store 108 of the social networking system 100. A user profile includes declarative information about the user that was explicitly shared by the user, and may also include profile information inferred by the social networking system 100. In one embodiment, a user profile includes multiple data fields, each data field describing one or more attributes of the corresponding user of the social networking system 100. The user profile information stored in user profile store 108 describes the users of the social networking system 100, including biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 100 displayed in an image. A user profile in the user profile store 108 may also maintain references to actions by the corresponding user performed on content items in a content store 116 of the social networking system 100 and stored in an action log 112 of the social networking system 100.

While user profiles in the user profile store 108 are frequently associated with individuals, allowing people to interact with each other via the social networking system 100, user profiles may also be stored for entities such as businesses or organizations. This allows an entity to establish a presence on the social networking system 100 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 116 stores content items associated with a user profile, such as images, videos and audio files. Content items from the content store 116 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social networking system 100 by displaying content related to users, objects, activities, or functionalities of the social networking system 100. Examples of social networking content items include suggested connections or suggestions to perform other actions, media provided to, or maintained by, the social networking system 100 (e.g., pictures or videos), status messages or links posted by users to the social networking system, events, groups, pages (e.g., representing an organization or commercial entity), and any other content provided by or accessible via the social networking system.

The content store 116 may also include one or more brand pages associated with user profiles of entities. A brand page comprises content associated with the entity and instructions for presentation of the content to a social networking system user. For example, a brand page identifies content associated with the entity's user profile as well as information describing how to present the content to users viewing the brand page. The content item store 116 may also store one or more targeting criteria associated with each content item in the store. The targeting criteria identifies one or more characteristics of a user to which a content item is to be delivered.

An action logger 110 in the social networking system 100 receives communications about user actions on and/or off the social networking system 100, populating the action log 112 with information about user actions. Examples of actions include: adding a connection to another user, sending a message to another user, uploading an image, reading a message from another user, viewing content associated with another user, attending an event posted by another user, or other suitable actions. In some embodiments, the action logger 110 identifies interaction between a social networking system user and a brand page within the social networking system 100, which communicates targeting criteria associated with content on the brand page to a content server 102 to customize content from the brand page. Actions performed by users to a brand page may include actions defined by the brand page. For example, an entity associated with a brand page may define custom actions using customized fields or interactive elements in the brand page. Additionally, a number of actions described in connection with other objects are directed at particular users, so these actions are associated with those users as well. Actions received by the action logger 110 are stored in the action log 112.

The action log 112 tracks user actions on the social networking system 100, as well as actions on external websites that communicate information to the social networking system 100. Users may interact with various objects on the social networking system 100, including commenting on posts, sharing links, and checking-in to physical locations via a mobile device, accessing content items in a sequence or other interactions. Information describing these actions is stored in the action log 112. Additional examples of interactions with objects on the social networking system 100 included in the action log 112 include commenting on a photo album, communications between users, becoming a fan of a musician, adding an event to a calendar, joining a group, becoming a fan of a brand page, creating an event, authorizing an application, using an application or engaging in a transaction. The action log 112 records a user's interactions with advertisements on the social networking system 100 as well as other applications operating on the social networking system 100. In some embodiments, data from the action log 112 is used to infer interests or preferences of the user, augmenting the interests included in the user profile and allowing a more complete understanding of user preferences.

The action log 112 may also store user actions taken on external websites. For example, an e-commerce website that primarily sells sporting equipment may recognize a user of a social networking system 100 through social plug-ins that enable the e-commerce website to identify the social networking system user. Because users of the social networking system 100 are uniquely identifiable, e-commerce websites may use the information about these users as they visit their websites. The action log 112 records data about these users, including webpage viewing histories, advertisements that were engaged, purchases made, and other patterns from shopping and buying.

A newsfeed manager 118 selectively provides content to users of a social networking system 100 and records the consumption of content by users. In one embodiment, the newsfeed manager 118 generates stories for a user describing actions taken by other users of the social networking system 100 to whom the user is connected. In one example, the newsfeed generated by the news feed manager 118 for a user includes comments made by other users to whom the user is connected. In another example, the newsfeed generated includes content posted to the social network system 100 by other users of the social networking system to whom the user is connected or other actions taken by other users to whom the user is connected. New newsfeed stories generated for a user by the news feed manager 118 may be ranked and stored by the social networking system 100. The news feed manager 118 may communicate with client devices 130 through the network 120 to provide content to users of the social networking system 100.

In one embodiment, a news feed manager 118 may provide content through a social plug-in, such as an iframe, to a third party website to provide content posted on the social networking system 100 about an entity associated with the third party website. As an example, a business entity creating a brand page on the social networking system 100 may desire to publish content items posted on the brand page's newsfeed to a third party website via a social plug-in installed on the third party website.

A social graph store 104 stores nodes and edges representing characteristics of social networking system users and connections between social networking system users and other objects included in the social graph store 104. Each node in the social graph may represent an entity that can act on another node and/or that can be acted on by another node. The social graph may include various types of nodes. Examples of types of nodes include users, non-person entities, content items, web pages, groups, events, messages, concepts, and any other things that can be represented by an object in the social networking system 130. An edge between two nodes in the social graph represents a particular kind of connection between the two nodes, which may result from an action that was performed by one of the nodes on the other node. For example, when a first user identifies a second user as a friend, an edge in the social graph is generated connecting a node representing the first user and a second node representing the second user. As various nodes interact with each other, the social networking system 130 modifies edges connecting the various nodes to reflect the interactions and connections between users and/or other users or objects. Further descriptions of embodiments of the graph store 104 are described below and related systems are described in U.S. patent application Ser. No. 12/764,928, filed Apr. 21, 2010, now issued as U.S. Pat. No. 8,250,145, and U.S. patent application Ser. No. 12/764,929, filed Apr. 21, 2010, both of which are hereby incorporated by reference.

Content provided to users by the social networking system (“social networking content”) is managed by the content server 102, which selects social networking content from data in the social graph store 104, the advertising campaign store and/or the content store 116 for presentation to a user via the user device 130 as the user navigates through pages or other portions of content on the social networking system 100.

An advertising campaign store 106 includes advertising campaigns established by various advertisers. An advertising campaign comprises a plurality of advertising requests each including advertisement content, targeting criteria identifying attributes of users to receive advertisement content, and a bid. Advertisement content includes an advertising creative and may also include instructions for associating social information with the advertisement.

Advertisement content may be a social advertisement or a sponsored story. A social advertisement has an advertising creative including content provided by an advertiser and combines social information with the advertising creative to provide content more personalized to a viewing user. Additionally, when presenting content to a viewing user, the social networking system 100 may describe actions performed by other users of the social networking system 100, such as users connected to the viewing user. Often, these descriptions of actions performed by other users are presented to the viewing user as stories identifying the action and the user performing the action. The social networking system 100 may use a variety of factors in selecting stories for presentation to the viewing user. Advertisers may compensate the social networking system 100 for presenting stories selected by the advertiser to users. This allows the advertiser to “sponsor” stories to increase the likelihood that the stories are presented to social networking system users. Hence, sponsoring a story allows advertisers to provide an incentive to the social networking system 100 to increase the likelihood that users view the story. Embodiments of sponsored stories and social advertisements, are described in U.S. application Ser. No. 12/193,702, filed Aug. 18, 2008, published as U.S. Patent Application Publication No. 2009/0119167, which is hereby incorporated by reference in its entirety. Stories may also be promoted based on user actions, such as identifying a preferred page or brand within the social networking system.

Both social advertisements and sponsored stories may use social information in the advertisement and in the targeting criteria. In one embodiment, at least a portion of the advertisement content is updated to include social information associated with the user to be presented the advertisement content. The social information included in the advertisement content is determined based on the user being presented the advertisement and/or information included in the advertisement content.

The social graph store 104 maintains data about users of the social networking system 100 and connections made by these users. Users and other entities are represented in the social graph store 104 as various types of objects, which are nodes in a social graph. Users of the social networking system establish connections to other entities in the social graph that are represented as nodes edges between nodes in the social graph. Various types of connections may be established between entities stored in the social graph store 104, with connection type associated with edges. For example, such connection types indicate that a user is a friend of another user, that a user is identified in a particular photo, or that a user likes a page associated with a company. The connections and connection types may be defined by the social networking system 100 or dynamically created and defined by objects maintained by the social networking system 100. For example, a node representing a footwear company may create a custom connection type allowing a user to provide data to the social networking system 100 that the user wears shoes manufactured by the footwear company or maintain an exercise tracking application allowing the social networking system 100 to store connections between users and the application that specify the miles run by the user in a day. Hence, the connections allow the social networking system 100 to store data describing interactions between various objects in the social graph store 104.

Objects in the social graph store 104, and their corresponding nodes in the social graph, may be associated with advertisers. The objects in the social graph store 104 allow advertisers to base targeting content and/or social content of advertisement content on connections in the social graph between objects associated with advertisers and other objects and/or interactions between users and other objects. For example, connections having a particular connection type may be aggregated to determine statistics for use in advertising. The aggregated edge types may be from a user to another object in the social graph store 104, or may be related to another object to which the user is connected. Examples of aggregated edge types include connections to other users, connections to a photograph, and connections associated with other objects connected to the user. Aggregated edge types may also include connections relating to the object associated with the advertiser, such as connections of a specified connection type between a user and the object associated with the advertiser, which may be used as targeting criteria for advertisement content or as information included in advertising content. Examples of targeting advertisements using edge types are described in U.S. application Ser. No. 13/252,901, filed Oct. 4, 2011, which is hereby incorporated by reference in its entirety.

Thus, the social networking system 100 provides a platform for advertisers to connect with users using social statistics and connection types, such as custom connection types defined by an advertiser. By analyzing connections in the social graph store 104 to obtain information about interactions between objects in the social graph store 104, the social networking system 100 allows advertisers to tailor advertisement content to a user based on the analyzed connections.

### Social Graph

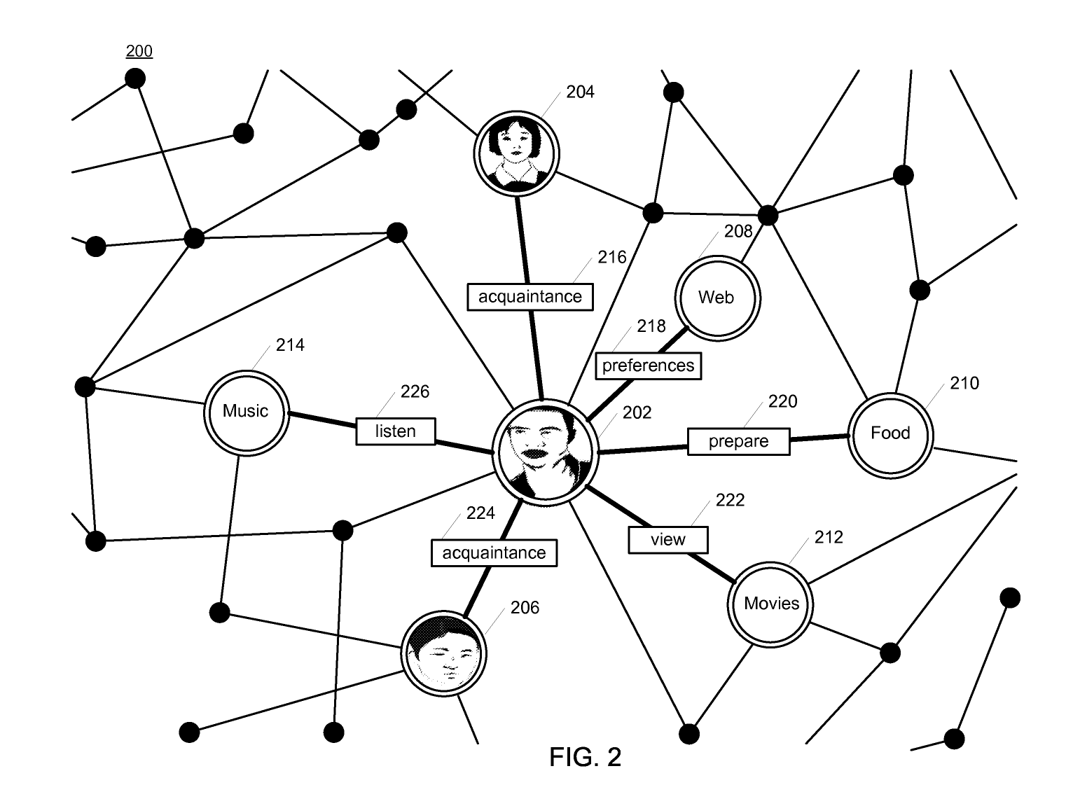

FIG. 2 illustrates an example social graph. The social graph 200 shown in FIG. 2 includes nodes 202, 204, 206, 208, 210, 212, and 214, representing a variety of social networking system objects that can act on and/or be acted upon by another node. In FIG. 2, nodes 202, 204, and 206 represent user objects. Node 208 represents a page object associated with an external website, while node 210 represents a recipe object from a cooking application. Also, node 212 represents a video object (e.g., a movie) from a video streaming application, and node 214 represents a song object from a music streaming application.

An edge between nodes in the social graph 200 represents a connection between the nodes, which may have a particular connection type. For example, an edge 216 between node 202 and node 204 has a connection type of “acquaintance” to show the relationship between the users corresponding to node 202 and node 204; similarly, an edge 216 between node 202 and node 206 also has an “acquaintance” type to show a relationship between users corresponding to node 202 and node 206. In another example, an edge 218 having a “preference” connection type connects node 202 with node 208 to illustrate that the user corresponding to node 202 “likes” or prefers the page object corresponding to node 208.

Connections, represented by edges, may be created from an action performed by a node on another node. For example, the user represented by node 202 performs an action “prepare” the recipe associated with the object corresponding to node 210, so an edge 220 having a “prepare” connection type is created between node 202 and node 210. Similarly, the user represented by node 202 performs an action of “listen” 226 for the song associated with node 214, causing an edge 226 with a connection type of “listen” to be crated between node 202 and node 214. In FIG. 2, the user corresponding to node 202 also performs view action on the movie corresponding to node 212, so an edge 222 with a “view” connection type is created between node 202 and node 212. Examples of other actions include listing social networking system objects in a user profile, subscribing to or joining a social networking system group or fan page, sending a message to another social networking system user, making a purchase associated with a social networking system object, commenting on a content item, or responding to an invitation to an event. Hence, the social graph 200 allows the social networking system 100 to represent objects in the social networking system 100 as well as relationships or associations between the objects.

### Custom Edges

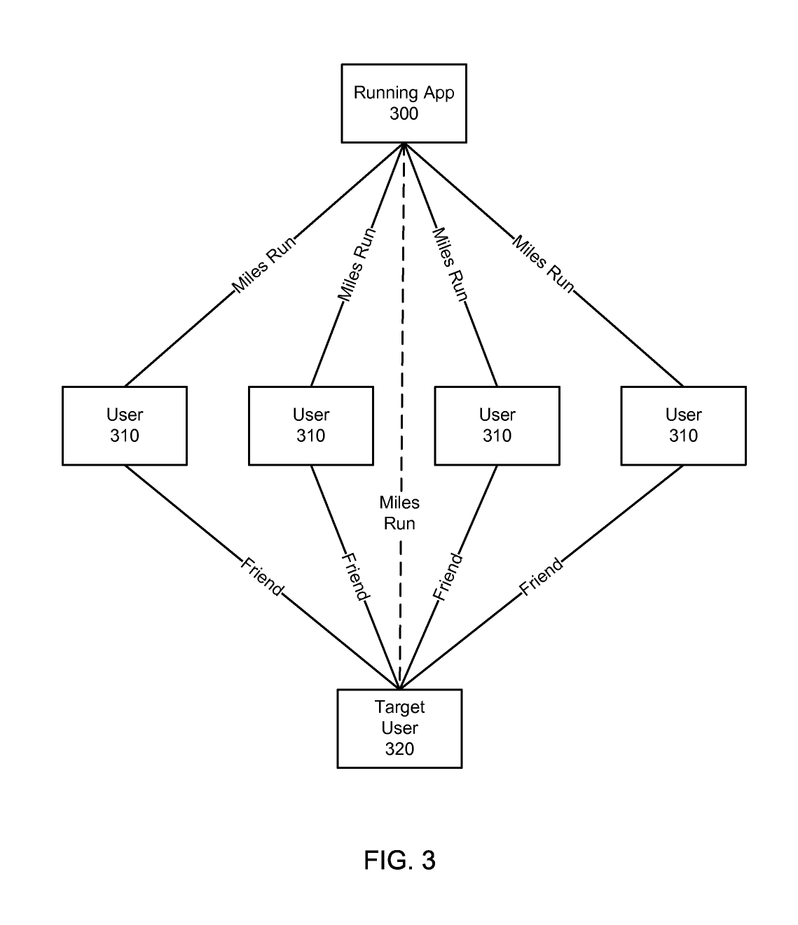

FIG. 3 illustrates an example of custom connection types connecting a target user 320 with a running application 300. A custom connection is a connection type created by an advertiser or other user of the social networking system 100 rather than the social networking system 100. An entity or application associated with a brand page may define a custom connection or another service in the social networking system 100 associated with a brand page may create a custom connection. An application is a portion of the social networking system 100 providing a customized interface to a user, such as a game. For example, a user interacting with a specified button, link, for or other input mechanism on a brand page creates a custom connection between the user and the brand page. As another example, user interaction with an application creates a custom connection; for example, as a user advances through levels of a gaming application, custom connections may be generated between the user and the application based on the completed levels. As another example, an application, such as a running application, may be created when a user inputs data to the application. In the example of the running application, a custom connection may be created when the user inputs number of miles the user ran in a particular day to the application.

In the example of FIG. 3, the running application 300 is associated with an advertiser, which may use connection information about the target user 320 in an advertisement. The target user 320 uses the running application 300 in the social networking system 100 by providing information to the running application 300 such as the number of miles run by the target user 320 in a given day or week. Though shown here as a single connection, each user may have a plurality of “miles run” connections to the running application 300, with connection describing a single running activity by the user. The target user 320 is also connected to a plurality of users 310 in the social graph store 104. In the example of FIG. 3, the users 310 are also users of the running application 300 providing information about the number of miles they have run to the running application 300.

Advertisements provided by the advertiser associated with the running application 300 may define statistics to generate that are determined from connections between users 310 and the running application 300. In this example, the “miles run” connection type is an edge type defined by the running application 300, or the advertiser associated with the running application 300. Hence, the social graph store 104 establishes connections between the users 310 and target user 320 having the “miles run” connection type based on information as defined by the running application 300.

In one embodiment, the social networking system 100 also identifies social statistics that may be of interest to an advertiser. For example, the social networking system 100 accesses the social graph store 104 based on an edge type and an optional object type. The edge type and object type may be selected by the advertiser or the social networking system 100 may select an edge type and/or an object type and provide the suggestions to possible advertisers. Using the edge type and/or object type, the social networking system 100 identifies users associated with the specified edge type, objects associated with the specified edge type and information about users, edges and/or objects associated with the selected edge type and/or object type. The social networking system 100 may analyze the information about the identified users, objects edge and/or to identify an edge type or object type for the advertiser.

For example, the social networking system 100 identifies users associated with an edge type of “miles run” and analyzes the associated users and the specified edge type to identify information for an advertiser. In the preceding example, the analysis may show that users that run twice a week also tend to like a brand page associated with the running application. As another example, the analysis may also reveal that users that run once a week have an average of 3 friends who also run once a week. Information from the analysis may be provided to an advertiser to specify a statistic for use in advertisement selection or targeting.

An advertising request using a statistic derived from the custom connection type of “miles run” includes a social statistic definition directing the social networking system 100 to aggregate information associated with connections to the running application 300 having the “miles run” connection type. The aggregated information associated with the custom connection type may be used to generate a social statistic that is included in advertising content or that may be used as targeting criteria to discern the target user 320 from other users 310. For example, the advertising request may include a social statistic definition that examines other users connected to the target user 320 that use the running application 300 and use information from the other users associated with connections having the “miles run” connection type in advertisement content. For example, the advertising request may include a social statistic definition specifying that data associated with “miles run” connections are used to identify users connected to the target user 320 who have run more miles than the target user 320, or users connected to the target user 320 who have run fewer miles than the target user 320. As another example, an advertising request may describe use of data associated with “miles run” connections are used to create a leader board of users connected to the target user 320 that is included in advertising content.

In various embodiments, the social statistics used in the advertisement content are derived from connections between the target user 320 and an advertiser associated with an application, connections between the target user 320 and other users, connections between target the user and photos, and connections between the target user and other applications. For example, a social statistic aggregates connections having a “miles run” connection type to determine the aggregated miles run of a user over a week and compares the statistics of “miles run” of the user and the user's friends. Examples of information about one or more connections defined by a social statistic includes the first connection stored, the last connection stored, the most connections having a connection type, the least connections of a connection type, the mean number of connections having a connection type, the mode of the number of connections of a connection type, and other various statistics of the connections. In one embodiment, use of the social statistics is restricted to the information known by the target user about the connections used to generate the social statistic. For example, if a user connected to the target user 320 has created a connection to the running application 300 having the “run miles” connection type but the miles information communicated to the running application 300 are affected by privacy settings that prevent the target user from seeing the connected user's miles information, the mileage information from the user connected to the target user 320 is not used in the advertisement content.

### Advertising Social Statistics

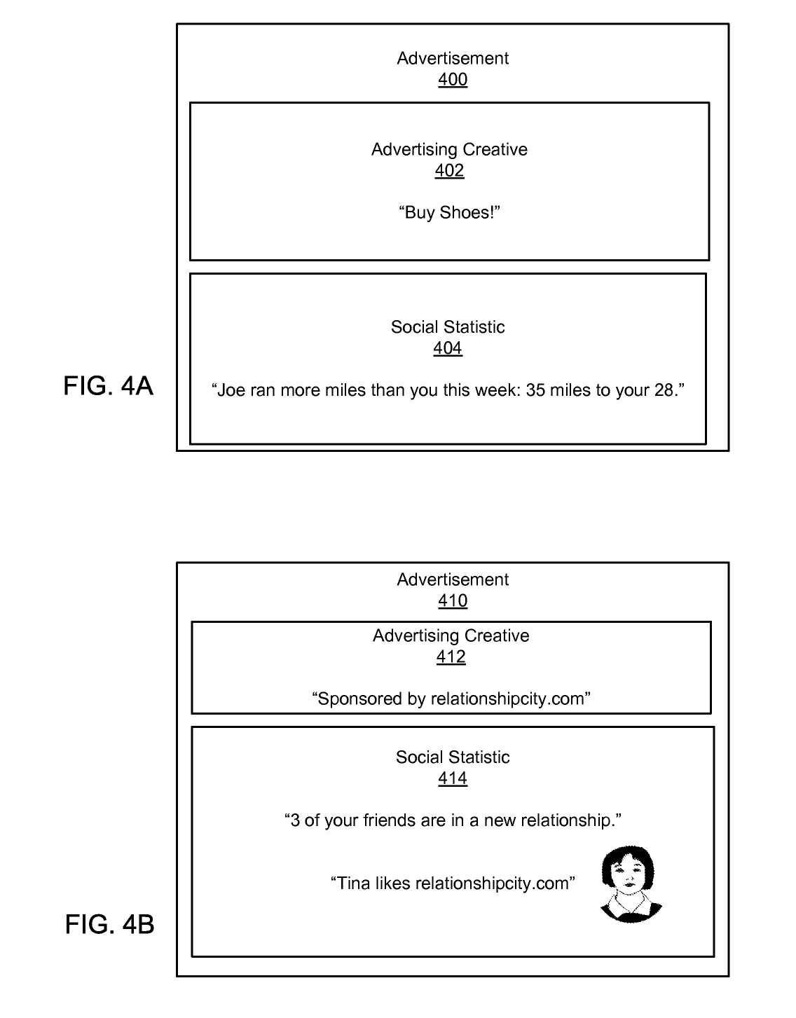

FIGS. 4A and 4B illustrate examples of two advertisements incorporating social statistics. The advertisement 400 includes an advertising creative 402 and a generated social statistic 404. The advertising creative 402 includes information from an advertising request associated with the advertisement 400 and is provided from the advertiser. The social statistic 404 provides information obtained from analyzing connections in the social graph store 104; hence, the advertisement 400 presents a user with information provided by the advertiser and information derived from the social graph store 104. In the example of FIG. 4A, the user to be presented the advertisement 400 is connected to a running application and provides the running application information about the user's running via one or more connections to the running application in a social graph.

As shown in FIG. 4A, the social statistic 404 for the advertisement 400 includes information about another user, Joe, connected to the user and Joe's information provided to the running application via one or more connections. Selection of the social statistic 404, in FIG. 4A, is provided based on information obtained by the social networking system 100 from connections having a connection type defined by the running application that is determined when the advertisement is selected 400 to be presented to the user. After the advertisement 400 is selected, the social statistic 404 is determined based on a social statistic definition in the advertisement request describing the connection type and a value to derive from connections having the connection type. In the advertisement 400, the social statistic 404 is chosen as another user connected to the user that has ran the most miles in the week. In addition, the social statistic 404 may be determined before the advertisement 400 is selected to be presented to a user and used as targeting criteria to identify one or more users to receive the advertisement 400. For example, the targeting criteria may be used to present the advertisement 400 to users who have ran at least 10 miles and connected to users that have ran more miles than the user.

FIG. 4B shows an additional example of using social statistics in advertising. The advertisement 410 also includes an advertising creative 412 for a dating service company. In this example, the generated social statistic 414 uses connection types between users of the social networking system 100. The connection type specified by the social statistic 414 indicates that a user's friends have formed new relationship connections to another user, and that one of the users connected to the user is also connected to the dating service company. In this example, the social networking system 100 may use information known about a user, connected to the user to be presented the advertisement 410, who formed a new relationship and who is also associated with the dating service company. In FIG. 4B, the user to be presented the advertisement 410 (or “viewing user”) may be selected using targeting criteria for the advertisement 410 that identifies a user that is connected to another user having a connection to the dating serviced company with a connection type indicating that the other user uses, likes, or found a match using the dating service company and has a connection to an additional user having a type indicating a relationship. The social statistic 414 is determined as which of the users connected to the user to be presented the advertisement 410 that have recently formed relationships. Further, the social statistic 414 or an additional social statistic may also include information about users connected to the user to be presented the advertisement who have connections to the dating service company.

### Additional Embodiments

In additional embodiments, advertisements may use a variety of social statistics to target advertisements and include social information in advertisements. For example, movies and music may be represented in the social graph store 104 as movie and music objects, respectively. An advertisement may be targeted to a viewing user connected to other users that have recently watched a movie associated with an advertiser. To select the viewing user, a social statistic used as targeting criteria is determined; for example, the targeting criteria specifies a user connected to other users that watch a threshold number of movies in a week. In this example, the number of movies in a week may be determined by counting the number of connections having a “watched” connection type connecting users to movie objects.

In addition to advertising, the social statistics may be used to recommend activities associated with the advertiser. For example, a bar operator may recommend that a user viewing an activity recommendation (a “viewing user”) go out with a user connected to the viewing user and that has checked-in to a threshold number of bars or restaurants. In this example, the user is recommended by counting the number of connections having a “check-in” connection type that connect users connected to the viewing user to objects corresponding to bars or restaurants. For example, a local bar may advertise a local trivia night with an advertisement: “Need a wingman? Bob checked into a bar twice times this week!” to encourage the user to join Bob, who is connected to the user, at trivia.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving an advertisement request from an advertiser, the advertisement request including advertising content and targeting criteria that identifies a user in a social networking system eligible for receiving an advertisement based on a type of interaction associated with the user in the social networking system and a definition of a social statistic associated with the type of interaction;
identifying a viewing user for receiving the advertisement based at least in part on the targeting criteria associated with the advertisement request;
identifying one or more other users who are connected to the viewing user in the social networking system;
selecting one or more users from the identified other users having performed the type of interaction specified by the targeting criteria of the advertisement request;
generating the social statistic for the viewing user based on the definition of the social statistic and the interactions having the type of interaction performed by the selected users;
generating a social advertisement that comprises the advertising content from the advertisement request and the generated social statistic; and
sending the social advertisement for display to the viewing user.

2. The computer-implemented method of claim 1, wherein the type of interaction associated with the user is between the user and an object in the social networking system.

3. The computer-implemented method of claim 2, wherein the object in the social networking system is associated with the advertiser.

4. The computer-implemented method of claim 1, wherein the type of interaction associated with the user is not associated with an object in the social networking system.

5. The computer-implemented method of claim 1, wherein the association of the type of interaction with the advertiser comprises association with an application in the social network associated with the advertiser.

6. The computer-implemented method of claim 1, wherein the definition of the social statistic comprises an instruction to generate a statistic associated with a user of the selected users that most recently performed the type of interaction.

7. The computer-implemented method of claim 1, wherein the definition of the social statistic comprises an instruction to generate a statistic associated with a total number of interactions performed by the selected users.

8. The computer-implemented method of claim 1, wherein the definition of the social statistic comprises an instruction to generate a statistic associated with a user of the selected users who most frequently performed the type of interaction.

9. The computer-implemented method of claim 1, wherein the definition of the social statistic comprises an instruction to generate a statistic associated with a user of the selected users who least frequently performed the type of action.

10. The computer-implemented method of claim 1, wherein generating the social advertisement comprises generating a sponsored story, the sponsored story comprising social networking content, advertising content, and the generated social statistic.

11. The computer-implemented method of claim 1, wherein the type of interaction is based on one or more criteria defined by the advertisement request.

12. The computer-implemented method of claim 1, wherein the generated social advertisement specifies the selected users performing the type of interaction.

13. The computer-implemented method of claim 1, wherein the generated social advertisement does not specify the selected users performing the type of interactions.

14. A computer-implemented method comprising:
receiving an advertisement request from an advertiser, the advertisement request including advertising content and targeting criteria that identifies a user in a social networking system eligible for receiving an advertisement based on a type of interaction associated with the user by the social networking system and a definition of a social statistic associated with the type of interaction;
identifying a viewing user for receiving the advertisement based at least in part on the targeting criteria associated with the advertisement request;
generating a social statistic based on the interactions associated with the viewing user and accessible to the viewing user based on the definition of the social statistic;
generating a social advertisement that includes the advertising content from the advertisement request and the generated social statistic; and
sending the social advertisement for display to the viewing user.

15. The computer-implemented method of claim 14, wherein the definition of the social statistic is an instruction to generate a statistic based in part on interactions performed by users connected to the viewing user.

16. The computer-implemented method of claim 14, wherein interactions accessible to the viewing user are interactions accessible to the viewing user based on privacy settings associated with the interactions.

17. The computer-implemented method of claim 14, wherein the association of the type of interaction with the advertiser comprises association with an application in the social network associated with the advertiser.
